(19) United States
(12) Patent Application Publication
(10) Pub. No.: US 2006/0123597 A1
(43) Pub. Date: Jun. 15, 2006

(54) Hinge and use thereof

(76) Inventors: Finn Andersen, Ry (DK); Henrik L. Pedersen, Sorring (DK); Glenn Hojmose, Silkeborg (DK)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/540,928

(22) PCT Filed: Dec. 22, 2003
(86) PCT No.: PCT/DK03/00928

§ 371 Date: Sep. 26, 2005

(51) Int. Cl. E05D 11/08

(52) U.S. Cl. 16/342

(57) ABSTRACT

A hinge for a child safety barrier, consisting of first (1, 9) and second (2, 10) bracket parts, wherein the first bracket part is formed with a pin (4) whose free end is formed with a shoulder (5). The second bracket part (2, 10) is formed with a hole (7) with two sections, where the first section has a larger diameter than the second section. This provides an edge between the two sections, which, together with the shoulder (5) of the pin, serves as a lock between the two bracket parts. If the length of the pin is larger than the length of the section of the smallest diameter, then the two hinge parts may be displaced relative to each other in the direction of the pin, which is an advantage when the hinge is used in connection with child safety barriers The two bracket parts of the hinge are formed with respective locking parts which cooperate such that when one bracket part is displaced relative to the other bracket part, the bracket parts may be rotated relative to each other.

The invention relates to a hinge consisting of first and second bracket parts, wherein the first bracket part is formed with a pin, while the second bracket part is formed with a hole to receive the pin.

Such hinges are used in many connections, such as in the mounting of doors of the conventional type. In addition, such hinges are used for doors in child safety barriers, playpens and like. In connection with the last-mentioned use, the hinges are frequently made of plastics, and instead of the pin a screw is used for the joining of the two bracket parts of the hinge. Since doors for child safety barriers are to be protected against unintentional opening, they are constructed in some cases such that a vertical lifting movement of the door must be carried out before it can be opened, which requires that the hinge of the door is prepared for this.

An example of such a door structure is known from WO 97/40253. This door structure has a hinge arranged such as to allow the door to be opened or closed after a vertical movement of the door has been carried out. The hinge is composed of several parts, including a bolt, in a rather complicated manner.

Accordingly, an object of the invention is to provide a hinge which is relatively inexpensive to manufacture.

The object of the invention is achieved by a hinge of the type defined in the introductory portion of claim 1, which is characterized in that the hole is made in two sections, one section having a larger diameter than the other section, and that a shoulder is provided on the pin. The hinge may hereby be made in two parts, with the shoulder serving as a lock which adjoins an edge defined by the area where the two sections of the hole meet.

When, as stated in claim 2, the shoulder is provided on a portion of the surface of the pin, and it is dimensioned to pass the section of the smallest diameter by pressure, a hinge is provided which may be assembled by pushing the pin into the hole by a force which is so great that the two parts of the hinge cannot readily be separated after assembly.

When, as stated in claim 3, the shoulder is provided near the free end of the pin, it is possible, by suitable selection of dimensions of the two sections in the second bracket part, to make a hinge where movement of the pin is allowed or not allowed.

This displacement may expediently be performed, when, as stated in claim 4, the section of the largest diameter is longer than the section of the smallest diameter.

For use where locking of the rotation of the bracket parts relative to each other is desired, it is an advantage if, as stated in claim 5, the first bracket part is formed with a locking part which cooperates with a locking part on the second bracket part.

These locking parts may expediently be constructed as stated in claim 6 in that the locking part on the first bracket part is formed by a box-shaped part which is terminated on a portion of its lower side by a plate-shaped part having larger horizontal dimensions than the box-shaped part, and that the plate-shaped part has a free surface which is flush with one free end of the box-shaped part, and, as stated in claim 7, in that the locking part on the second bracket part is formed by a box-shaped part which is terminated at its one end by a block-shaped part having larger horizontal dimensions than the box-shaped part, and that the block-shaped part has a free surface.

When, as stated in claim 8, the bracket parts are made of the same material, e.g. hard plastics as stated in claim 9, it is ensured that the manufacturing costs of the brackets may be kept reasonably low.

As mentioned, the invention also relates to use of the hinge.

This use is defined in claim 10.

The invention will now be explained more fully with reference to the drawing, in which

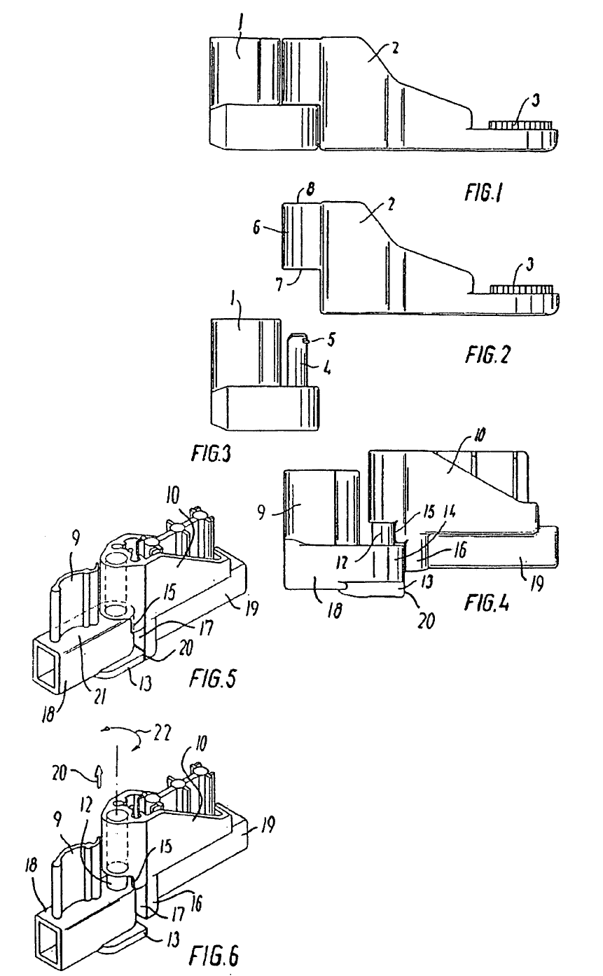

FIG. 1 shows a hinge according to the invention consisting of first and second bracket parts,

FIG. 2 shows the second bracket part of FIG. 1,

FIG. 3 shows the first bracket part of FIG. 1,

FIG. 4 shows a hinge in a second embodiment where the bracket parts are displaced relative to each other,

FIG. 5 shows the hinge of FIG. 4, seen obliquely from the side with the bracket parts in a locked state, while

FIG. 6 shows the hinge of FIG. 5 in a non-locked state.

In FIGS. 1 to 3, the numeral 1 designates a first bracket part, while 2 designates a second bracket part which has a tooth engagement capable of cooperating with onother tooth engagement (not shown), and the two tooth engagements may be positioned relative to each other by vertical displacement, e.g. as explained in connection with the safety barrier described in WO 00111301. The first bracket part 1, cf. FIG. 3, has a pin 4 adapted to engage a hole 7 on the second bracket part 2. The pin 4 moreover has a shoulder 5, as will be seen in FIG. 3.

The hole 7 is formed with two sections (not shown), where one section has a larger diameter than the other section. The section of the largest diameter is disposed at the end designated 8 in FIG. 2. The section of the smallest diameter has a diameter which allows the shoulder 5 on the pin 4 to pass only when it is subjected to a force, while the hole of the largest diameter allows the pin 4 with the shoulder 5 to move freely.

The function of the hinge will be explained now.

When the first 1 and the second 2 bracket parts are assembled, the pin 4 with the shoulder 5 on the first bracket part 1 is pressed into the hole 7 in the section of the smallest diameter. The two bracket parts are hereby locked together, but since the shoulder 5 is pressed into the section of the largest diameter, the two bracket parts may be moved relative to each other by rotation. If, moreover, the section of the smallest diameter has a length shorter than the pin 5, the two bracket parts of the hinge may be displaced mutually in the direction of the pin in addition to being rotated relative to each other, as the pin with the shoulder when displaced just slightly into the hole reaches the section of the largest diameter.

Such a displacement of the bracket parts relative to each other is shown in FIG. 4, which shows a hinge which is basically constructed like the hinge of FIGS. 1-3, but now provided with a locking function, as will be explained below.

In FIGS. 4-6, the numeral 9 designates a first bracket part, while 10 designates a second bracket part.

The first bracket part 9 is formed by a box-shaped part 18 which, on a portion of its lower side, is formed with a plate-shaped part 13 having horizontal dimensions which are larger than the box-shaped part. The free end 20 of the plate 13 is rectangular. The plate-shaped part 13 constitutes a first part of a locking mechanism which cooperates with a locking mechanism on the second bracket part 10.

As will be seen in FIGS. 5 and 6, also the second bracket part 10 is formed by a box-shaped part 19 which, on a portion of its lower side, is formed with a block-shaped part 16 which also has horizontal dimensions larger than the box-shaped part 19. The free end of the block-shaped part is formed as a square with a free surface 17. Finally, the second bracket part 10 is formed with two symmetrical collars 15 whose free ends are terminated a distance downwards by the free surface 17 so as to create a gap between the collars and the plate-shaped part 13 on the first bracket part 9.

It will now be explained how the hinge of FIGS. 4-6 works:

FIG. 5 shows the hinge in a locked state, where the locking function is provided by the plate member 13, with its free end 20 adjoining the free surface 17 of the block-shaped part 16.

Vertical displacement of the second bracket part 10 in the direction of the arrow 20 causes the block-shaped part 16 to be displaced relative to the plate-shaped part 13, which means that the bracket parts may rotate relative to each other, as indicated by the arrow 22.

In the rotation, the free surface 15 of one of the collars will slide on the upper surface of the box-shaped part 18, thereby providing stable fixing of the parts relative to each other.

The hinge described may advantageously be used in connection with the safety barrier described in WO 97/40253, in which the safety barrier has to be lifted before it may be rotated and thereby opened and closed, respectively.

1. A hinge consisting of first (1, 9) and second (2, 10) bracket parts, wherein the first bracket part is formed with a pin (4), while the second bracket part is formed with a hole (7) to receive the pin, where the hole (7) is made in two sections, one section having a larger diameter than the other section, wherein a shoulder (5) is provided on the pin (4), and wherein the section of the hole of the largest diameter is longer than the section of the smallest diameter.

2. A hinge according to claim 1, wherein the shoulder (5) is provided on a portion of the surface of the pin (4), and is dimensioned to pass the section of the smallest diameter by pressure.

3. A hinge according to claim 1, wherein the shoulder (5) is provided near the free end of the pin (4).

4. A hinge according to claim 1, wherein the first bracket part (9) is formed with a locking part (13, 18, 20) which cooperates with a locking part (16, 17, 19) on the second bracket part (10).

5. A hinge according to claim 4, wherein the locking part (13, 18, 20) is formed by a box-shaped part (18) which is terminated on a portion of its lower side by a plate-shaped part (13) having larger horizontal dimensions than the box-shaped part (18), and the plate-shaped part has a free surface (20) which is flush with one free end of the box-shaped part.

6. A hinge according to claim 4, wherein the locking part on the second bracket part is formed by a box-shaped part (19), which is terminated at its one end by a block-shaped part (13) having larger horizontal dimensions than the box-shaped (19), and the block-shaped part has a free surface (17).

7. A hinge according to claims 1 6, claim 1, wherein the bracket parts are made of the same material.

8. A hinge according to claim 7, wherein the material is hard plastics.

9. (canceled)

10. A child safety barrier which includes a hinge as defined in claim 1.
